(19) United States
(12) Patent Application Publication
(10) Pub. No.: US 2001/0040493 A1
(43) Pub. Date: Nov. 15, 2001

(54) Flexible sheet magnet and method

(76) Inventor: Stuart J. Bloom, Lancaster, MA (US)

Correspondence Address: WEINGARTEN, SCHURGIN, GAGNEBIN, & HAYES, LLP, TEN POST OFFICE SQUARE, BOSTON, MA, 02109, US

(21) Appl. No.: 09/748,525

(22) Filed: Dec. 22, 2000

Related U.S. Application Data
(60) Provisional application No. 60/173,949, filed on Dec. 30, 1999.
(60) Provisional application No. 60/250,162, filed on Nov. 30, 2000.

(51) Int. Cl. H01F 7/02

(52) U.S. Cl. 335/306

(57) ABSTRACT

A printable and flexible sheet material is coated with a magnet material of uniform thickness and flatness and which can be made in any practical width and length. In one embodiment, the magnet material is coated onto a release sheet and laminated to a web having a printable surface. Alternatively the magnet coating is applied directly to a printable web. Printed sheets produced in accordance with the invention can be employed in standard printing machines including inkjet, laser, offset, sublimation, flexographic or other printing machines.

### CROSS REFERENCE TO RELATED APPLICATIONS

The applicant claims the benefit under Title 35, USC §119(e) of U.S. provisional application Ser. No. 60,173,949 filed Dec. 30, 1999, and U.S. provisional application Ser. No. 60/250,162 filed Nov. 30, 2000, the disclosures of which are incorporated herein by reference.

### STATEMENT REGARDING FEDERALLY SPONSORED RESEARCH OR DEVELOPMENT

N/A

### BACKGROUND OF THE INVENTION

Flexible magnet materials are known and which generally comprise a sheet material which can contain printed information and a an extruded magnet layer which is adhesively attached to the back or non-printed side of the sheet. The magnetic material is a self supporting extruded sheet which which is usually rubber based. Such extruded materials can melt at elevated temperatures. As a result, sheets formed from such extruded rubber based material cannot be employed in laser printers or other printers having fusers which are at high temperatures sufficient to melt the rubber material. The extruded material is also subject to cracking if bent or folded. In addition the extrusion process is relatively expensive and employs customized equipment to form a magnetizable sheet material. The extruded material is also limited in width to typically 24 or 30 inches. It would be beneficial to have a printable sheet having a magnetizable layer which does not suffer the disadvantages of existing magnet sheets.

### BRIEF SUMMARY OF THE INVENTION

In brief, the present invention provides a printable flexible sheet material coated with a magnetizable layer of uniform thickness and flatness and which can be made in any practical width and length. In one embodiment, the magnet material is coated onto a release sheet and laminated to a web having a printable surface. In another embodiment the magnet coating is applied directly to the printable web. The sheet produced in accordance with the invention can be bent or folded without cracking and can be employed in laser and other high temperature printers without melting of the magnetizable material. The sheet can be very flexible and thin and provides good magnet adhesion. The magnetic layer is composed of one or more thin coats of magnet material which do not detract from the inherent properties of the substrate web material.

The magnetizable material to be coated onto a flexible substrate sheet or web is a slurry containing a high proportion of magnet powder which preferably is strontium ferrite. The slurry is preferably water based to avoid toxic solvents. A solvent based slurry can also be used. The coating is applied in a succession of thin uniform coats applied across the entire width of the substrate. Substrate widths up to about 120 inches can be employed with present equipment. Various coating techniques can be employed to coat the magnet material on the substrate surface, including knife over roll, floating knife or roll over roll coating.

The substrate web may be a variety of paper, film, plastic, cloth, woven, non-woven materials and other materials which are coatable on a surface with a magnet layer. The substrate for many purposes has a printable surface on which text, graphics, pictures and the like can be printed. The sheet can be cut into suitable sizes to use as refrigerator style magnets which are adherable to any magnetically permeable surface.

In accordance with a first embodiment of the invention, a coating of magnet material is applied on the release surface of a release or casting sheet which is transported along a fabrication line. The casting sheet and applied magnet coating are transported through an oven to dry the coating. After drying, a second magnet coating is applied to the first coating and the casting sheet with the applied first and second magnet coatings are transported through a second oven to dry the second magnet coating. After drying of the second coating an adhesive layer is applied to the confronting surface of the second magnet coating. The adhesive layer can be an opacity layer as well. A substrate web having a printable surface is laminated with the non-printable surface in contact with the adhesive layer and pressure is applied by nip rollers or otherwise to provide good adhesion of the substrate to the dry magnet layer. The resulting laminated web is transported through a third oven to cure the adhesive. After leaving the third oven the casting sheet can be stripped from the magnet coating and may be rewound for reuse. The finished web can be wound onto a reel for further processing.

The magnet layer is magnetized by a permanent magnet magnetizer which is placed in contact with the surface of the magnetizable layer. The magnetizer can be employed after removal of the casting sheet so that the surface of the magnet layer can be placed in direct contact with the magnetizer for efficient magnetization.

In another embodiment of the present invention, one or more coats of the magnet material are applied directly to the printable substrate web without use of a release or casting sheet.

The web or sheets produced in accordance with the invention can be employed in standard printing machines including inkjet, laser, offset, sublimation, flexographic or other printing machines. Such web or sheets can also be fabricated using existing coating and web handling equipment which can have larger widths of at least 120 inches using presently available equipment. The resulting flexible sheet magnets can be produced at substantially less cost than conventional extruded magnets.

### BRIEF DESCRIPTION OF THE SEVERAL VIEWS OF THE DRAWING

The invention will be more fully understood from the following detailed description in conjunction with the drawings in which:

FIG. 1 is a diagrammatic representation of a first process for forming a printable magnet sheet in accordance with the invention;

FIG. 2 is a cutaway pictorial view of a magnetizer in accordance with the invention; and

FIG. 3 is a diagrammatic representation of a second process for forming a magnet sheet in accordance with the invention.

### DETAILED DESCRIPTION OF THE INVENTION

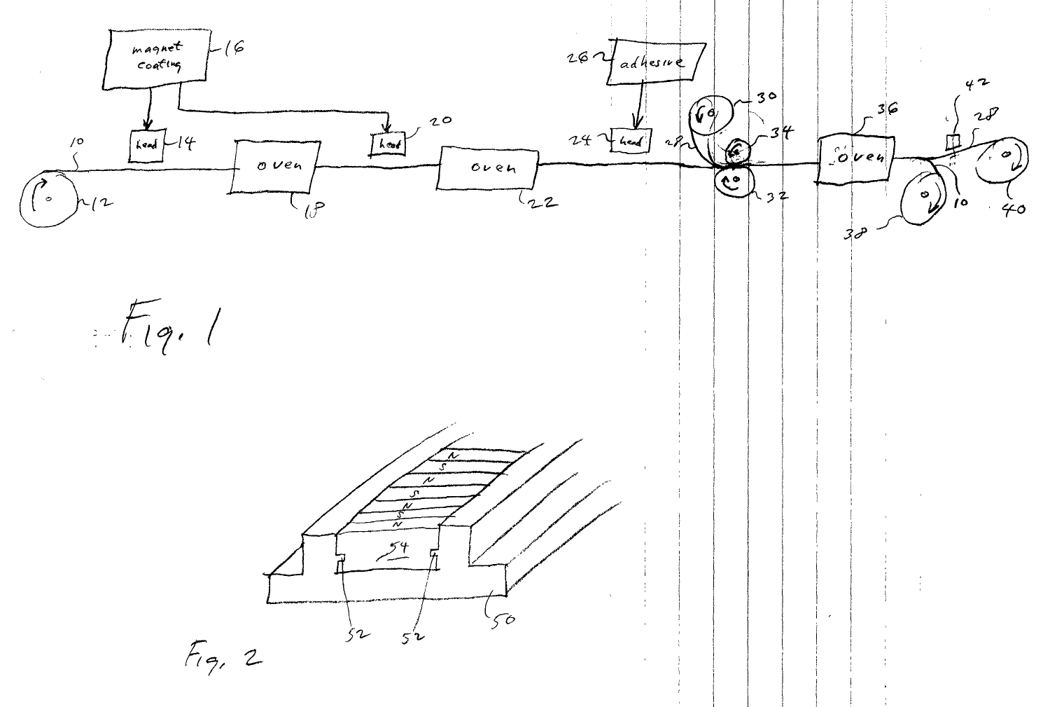

The process for making a printable flexible magnet in accordance with a first embodiment of the invention is illustrated in FIG. 1. A release or casting sheet 10 is supplied from a supply reel 12 and is conveyed along a processing path to successive stages of the processing equipment. The casting sheet is a silicone coated paper, the coated surface of which provides temporary adhesion to an applied magnet coating. The release or casting sheet can be of various other constructions which per se are known. The release surface is smooth and flat and the sheet is in the form of a web of sufficient length to be conveyed along the entire processing line. The casting sheet is conveyed along the processing line with the release surface facing upward. The sheet is conveyed past a first coating head 14 which is supplied with a magnet coating material from a supply vessel 16. The head 14 applies a thin uniform coating of magnet material, typically about 5 ounces dry, across the entire effective width of the sheet 10, and the coated sheet is then conveyed through a first oven 18 in which the applied coating is fully dried. The sheet then is conveyed past a second coating head 20 which is also supplied with magnet coating material from supply vessel 16. A second thin uniform magnet coating, also about 5 ounces dry, is applied over the dried first coating by head 20 and the coated sheet is then conveyed through a second oven 22 for drying of the second coating. The casting sheet with first and second dried magnet coatings thereon is next conveyed past a coating head 24 which is supplied with an adhesive material from a supply 26. The adhesive material a preferably a white opaque adhesive material. After application of a thin adhesive layer a printable web 28 from a supply reel 30 is laminated to the coated casting sheet by passage between nip rollers 32 and 34. The nip rollers squeeze and glue the web 28 to the dried magnet layer. The printable surface of web 28 is the outer surface opposite to the surface laminated with the adhesive to the casting sheet. The laminated web is conveyed through a third oven 36 in which the adhesive material is dried. After leaving the oven 36, the casting sheet is stripped from the laminated printable web and rolled onto a take-up reel 38. The web 28 is spooled onto a take-up reel 40. The magnet coatings on the underside of web 28 are magnetized by an applied magnetic field provided by a magnetizer 42 disposed in contact with the confronting surface of the magnet layer. The magnetizer can be at any convenient position along the processing line after the casting sheet has been stripped from the coated web.

The use of a casting sheet having a smooth release surface is beneficial in providing a magnet coating of corresponding uniformity and smoothness. The uniform and smooth coating of magnet material onto the casting sheet permits the application of relatively small amounts of coating material. Typically the coating weight is about five ounces per square yard for each coating layer. The thin coating permits faster drying of the magnet material, increased production speed at which a web can be conveyed along a processing line, and reduced material cost by reason of the smaller amount of material that need be applied.

The process illustrated in FIG. 1 is an inline process employing multiple coating heads. The printable magnetic sheet can also be fabricated in a non-inline manner using batch type equipment. In this latter circumstance a casting sheet is coated with a first layer of magnet material which is then dried. Thereafter the coated sheet is conveyed past the coating head of the same machine or another machine to provide the second magnet coating and drying operations. The process can continue in step wise fashion on respective machines to provide the finished product.

In the above described embodiment first and second magnet coatings are applied to the casting sheet. It will be appreciated that additional coatings of magnet material can be provided and may be desirable in particular circumstances to provide a layer of intended thickness and magnetic strength. In some instances a single magnet coating is sufficient.

In the illustrated embodiment the casting sheet is removed from the coated web prior to reeling or subsequent processing of the coated web. For some purposes the casting sheet can be left attached to the coated web to protect the magnet surface during subsequent processing steps or during shipment of the product prior to ultimate use.

Magnetization of the magnet layer can be accomplished at any time after the magnet coatings are dried and the casting sheet has been removed. In the illustrated embodiment the magnetizer 42 is shown juxtaposed with the magnet surface of web 28 after stripping of the casting sheet and prior to reeling of the magnetized web. Alternatively, magnetization can be accomplished after various other process steps such as after printing of the printable surface of the web 28. Magnetization can also be accomplished after the web is cut into intended sheets, but it is usually preferable to magnetize the web in uncut form by continuously passing the web across the magnetizer.

The invention employs a magnetizer composed of an array of permanent magnets which extend across the entire effective width of the web. This structure is substantially less expensive than electromagnets that are conventionally employed in magnetizing magnet surfaces.

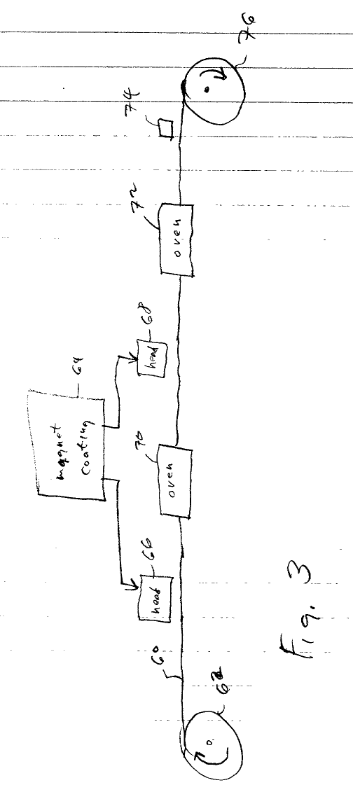

The magnetizer is shown in FIG. 2 and comprises an aluminum or other non-magnetic base 50 having a central channel extending the length thereof and first and second ridges 52. A plurality of permanent magnets 54 are disposed in side by side relationship in the central groove each of the magnets having side grooves which are cooperative with ridges 52 to key or lock the magnets into the base 50. The magnets 54 are held together by an appropriate adhesive such as methylmethacrylate glue so that the array of magnets provides an effectively continuous magnetic surface. The adjacent magnets are oppositely polled such that the magnet array provides a sequence of north and south poles which alternate along the length of the array. The magnets can be of any suitable material and typically are niodinium-iron-boron or summerium-cobalt. A typical pole pitch is 18 poles per inch. The permanent magnets are substantially less costly than electromagnets which are conventionally employed since no power supplies or relatively complex electromagnetic windings are necessary. The magnetizer can be made of any practical length to encompass the full width of the web. The high pole pitch permits the magnetized sheet to adhere to other magnet sheets without necessity of pole alignment.

The magnetizer is mounted in a position to permit the surface of the magnetizable layer of web 28 to contact the exposed ends of magnets 54 to magnetize the layer across the entire width thereof. The magnet layer of web 28 tends to adhere to the magnets 54 when placed close to the magnets, and the positions of the web in relation to the magnetizer can be maintained by use of a nip roller which can be constructed of non-magnetic material.

The web 10 is in rolls of 60 inches in width. The width is limited only by the operative widths of available coating equipment. Such coating equipment is presently available in widths up to 120 inches.

The printable surface of the web may be print ready by pre- application of appropriate coating materials, or print ready coatings can be provided to the printable surface after fabrication of the coated web.

The use of a casting sheet is particularly desirable since streaks or other imperfections which may form on the magnetic or magnet surface by reason of artifacts of the coating step are substantially eliminated since the magnet surface which ultimately will be the exposed bottom surface of the finished sheet is in contact with the flat smooth surface of the casting sheet. The magnet coating does not suffer so called strike off in which particles can rub or fall off of the magnet surface and mar or smudge the printing surface of the web.

The magnet sheet formed according to the invention retains the properties of the web material since the magnet coatings are very thin and flexible. The magnet sheet remains very flexible much like a paper or other thin sheet and is bendable without cracking. Creases in the sheet can be ironed out without danger of melting the material as would occur with conventional rubber based magnet materials. The web material can be perforated to provide for easy separability of magnet sheets from a larger web or sheet. The overall magnet sheet is typically about 16 mils in thickness which is substantially thinner than conventional extruded sheets. The magnet sheets are also of significantly lower weight than conventional extruded sheets.

Another embodiment is shown in FIG. 3 in which the magnet coatings are applied directly to a surface of the substrate web. The process is similar to that described above except that no casting sheet is employed. A printable web 60 is supplied from a reel 62 and conveyed along a processing path. A magnet coating material provided from a supply 64 is conveyed to a first coating head 66 and a second coating head 68. The head 66 applies a first coating of magnet material to the confronting surface of web 60 which is dried in a first oven 70. The second coating head 68 provides a second magnet coating over the first dried coating and this second coating is dried in a second oven 72. The magnet coating is conveyed past a magnetizer 74 for magnetization of the magnet coating and the web is then wound onto a take-up reel 76. The material on reel 76 can be subsequently processed into final product form. For example, the magnetized web can be printed and then cut into sheets for packaging and sale. Alternatively, printing can be accomplished on the web before it is wound onto a take-up reel and thereafter cut into individual sheets.

The coats of magnet material are applied to the web to provide a final coating or layer of intended thickness having intended magnetic adhesion. The web material can be paper or non-woven material to produce sheets which are not adversely affected by the magnet coating such that the sheets can be processed in standard printing and handling equipment.

One example of the magnet coating composition is noted below with the percentage weights being wet weight percentages:

| | |
|---|---|
| Water | 20.7% |
| Dispersant | 0.5% |
| Binder | 18.3% |
| Thickener | 1.5% |
| Humectant | 1.2% |
| Magnet Powder | 57.8% |

The dispersant is preferably a non-ionic dispersant such as Daxol 30. The binder is preferably an acrylic binder. The thickener is preferably a polyacrylate. Preferably the magnet powder is strontium ferrite.

In the above example the dispersant is itself about 73% water, although various dispersants can be used having a water content from about 80% to 0%. The binder noted above is 40% water but binders having a water content in the range of about 40-55% can be employed. The thickener noted above is about 65% water but thickeners having a water content in the range of about 62-85% can be employed. The humectant is usually dry as is the magnet powder. The strontium ferrite or other magnet powder as measured by dry weight is about 82% of the total dry weight.

The strontium ferrite particles are preferably hexagonal platelets of polycrystalline form. To prevent the crystals from cracking the strontium ferrite should be manufactured at high temperature typically above 2250° C. to provide a hard crystalline material which tends to break during grinding along crystal planes rather than cracking as less hard materials will tend to do, to provide crystals which have less mechanical damage and which provide sufficient magnetic energy. The harder multi or polycrystalline strontium ferrite material is generally considered of lower grade than so called higher energy materials but it turns out to be better for present purposes since during grinding into a coatable material the crystals remain magnetically suitable.

The order of adding the ingredients in formulating the coating composition is not critical. The material can have a viscosity in the range of about 30,000-70,0000 centipoise as measured on the Brookfield scale. The composition is mixed in a attriter, ball mill or other machine operative to reduce the particle size of the powder to provide a mixture of uniform magnetic particle size or size range without clumping or a conglomeration of particles in the mix which could cause an uneven or streaked coating surface.

As an example, 220 pounds of composition (wet weight) are ball milled for about 4 hours to provide a composition ready for coating. The milling achieves a smooth coatable material which can be applied as a smooth coating on the substrate. The coating material has a relatively long shelf life of at least six months and still provide uniform coatability.

In one process using a knife over roll machine, a non-woven or woven substrate is conveyed by means of a pin tenter frame through the coater at a speed of about 5-15 yards per minute. A coating thickness in the range of about 2-16 ounces (dry weight) per square yard is coated onto the surface of the substrate. The coated substrate is then passed through a drying oven having an oven temperature of about 225-350° F. The knife gap is about 1-15 mils. over the web surface.

For coating a paper substrate a similar process is employed but a pin tenter frame is not needed. The substrate is fed directly to a knife over roll coater or other coater mechanism.

The magnet coating is usually applied in multiple thin layers to provide an intended overall coating thickness and a coated material which does not curl or crack. The individual coatings can be of different thicknesses. As an example, an initial coating of about 8 ounces can be applied, followed by a second coating of about 6 ounces. Further coatings could be implied to suit particular specifications. A substantially uniform coating is provided across the entire width of the substrate. Coating uniformity is about ±1 ounce across the width of the substrate web.

The magnetic coated material will not stick to other sheets in a stack since the field strength of the stacked sheets is not sufficient to magnetically adhere each sheet to the other. Thus the magnetically coated sheets can be stacked and handled by conventional paper or sheet handling equipment such as feeder for printing machines.

Various pre-coating or post-coating steps may be applied as desired for particular applications. For example for printing substrates, a plain white or other solid color may be desirable with no show through of the black magnet coating on the opposite surface. Titanium dioxide may be applied as an opacity pre-coat on the substrate. Any other water based or other appropriate opacity pre-coat may also be applied. The titanium dioxide is usually in the form of a composition having about 50% titanium dioxide powder and about 50% polymer. The pre-coat is applied at a weight of about 1.5 ounces per square yard. Such opacity pre-coating is usually needed for thinner papers or films where an opaque printing surface is desired.

Various post-coatings may be applied to the printed surface such as inkjet coating for use in inkjet printers, or other receptivity coatings appropriate for particular types of printers.

Non-woven cloth materials are often preferred as a substrate since such materials can be readily folded and ironed. The cloth surface is typically vacuum cleaned prior to offset or other blanket roll printing.

One application of the flexible magnet sheets is as a printable material which can be magnetically adhered to a magnetically permeable surface. The material may be cut into intended sizes and shapes to provide refrigerator magnets having artistic or graphical depictions which may be customized to provide magnetically adherable labels, pictures, text and the like. Another use is as a wall covering having intended decoration on the printed surface. A further use for the coated material is in making wide magnet sheets which need not have any printable surface. Such magnetic material may be used for magnetic gasketing and shielding for example.

The magnet material may also be used for magnetic therapy wherein the magnetic coated flexible material may be incorporated into bandages or other materials to be wrapped about or applied to a body part or to skin. A hypoallergenic adhesive or other coating may be employed over the magnetic coating for contact with the skin. The magnet material may also be incorporated into blankets and bed sheets for example.

The invention is not to be limited by what has been particularly shown and described but is to encompass the spirit and full scope of the claims.

What is claimed is:

1. A printable sheet having a magnetized coating comprising:
a substrate web having a printable surface and an opposite surface; and
one or more coatings of magnet material of uniform thickness across substantially the entire opposite surface of the substrate web, the coatings having strontium ferrite particles which comprise at least 80% of the dry weight of the coating material.

2. A method of forming a flexible magnetizable sheet comprising the steps of:
providing a substrate web having a printable surface and an opposite surface;
applying at least two coatings of liquid magnetizable material in a thin uniform layer across the entire effective width of the opposite surface of the sheet;
drying each of the coatings before application of any subsequent coating; and
applying a magnetic field to the magnetizable coatings to permanently magnetize the coatings.

3. The method of claim 2 including the steps of:
conveying the substrate web along a processing path;
disposing stations along the processing path to perform the applying and drying steps; and
disposing a magnetizer in contact with the dried magnetizable coatings to permanently magnetize the coatings.

4. The method of claim 3 wherein the coatings comprise a slurry having a substantial proportion of strontium ferrite particles therein.

5. The method of claim 4 wherein the strontium ferrite is present in the coating slurry at a dry weight of about 82% of the total weight.

6. A method of forming a flexible magnetizable sheet comprising the steps of:
providing a casting sheet having a smooth release surface;
applying a first coating of liquid magnetizable material in a thin uniform layer across the entire effective width of the release surface;
drying the first coating;
applying a second coating of liquid magnetizable material in a thin uniform layer across the entire effective width of the first coating on the release surface;
drying the second coating;
providing a web having a printable surface and an opposite surface;
laminating the opposite surface of the web to the second coating; and
applying a magnetic field to the first and second coatings to permanently magnetize them.

7. The method of claim 6 wherein the laminating step includes applying adhesive to the opposite surface of the web and laminating the web to the second coating via the adhesive.

8. The method of claim 6 including the step of applying a pre-coating on the web.

9. The method of claim 6 including the step of applying a post-coating on the web.

10. The method of claim 9 wherein the post-coating is to enhance the printablility of the printable surface of the web.

11. The method of claim 6 wherein the steps of applying first and second coatings of liquid magnetizable material include applying the material at a thickness in the range of 2-16 ounces (dry weight) per square yard.

12. A magnetizer for use in permanently magnetizing a coating on a surface of a flexible web, comprising:
a nonmagnetic base having a channel along the length thereof;
a plurality of permanent magnets contiguously disposed in the channel and secured therein;
the magnets being oppositely poled to provide an array of alternate north, south poles along the length of the channel; and
the pole faces of the plurality of permanent magnets defining an effectively continuous surface for contact with the coating of the web to be magnetized.

13. The method of claim 12 wherein the strontium ferrite particles are polycrystalline.

14. The method of claim 6 wherein the coatings comprise a slurry having a substantial proportion of strontium ferrite particles therein.
